(19) United States
(12) Patent Application Publication
(10) Pub. No.: US 2024/0045420 A1
(43) Pub. Date: Feb. 8, 2024

(54) SYSTEM AND METHOD FOR PROVIDING AUTONOMOUS UNCREWED Vehicle OPERATION

(71) Applicant: Darkhive, Inc., San Antonio, TX (US)

(72) Inventors: Steven Turner, Nevada City, CA (US); John Goodson, San Antonio, TX (US)

(73) Assignee: Darkhive, Inc., San Antonio, TX (US)

(21) Appl. No.: 18/228,839

(22) Filed: Aug. 1, 2023

Related U.S. Application Data
(60) Provisional application No. 63/394,389, filed on Aug. 2, 2022.

(51) Int. Cl. G05D 1/00; G10L 15/22; G06F 3/16; B64U 10/10

(52) U.S. Cl. CPC G05D 1/0016; G10L 15/22; G06F 3/167; G05D 1/0022; B64U 10/10; G10L 2015/223; B64U 2201/20

(57) ABSTRACT

A computer-implemented system and method for operating one or more uncrewed vehicles (UxSs) in autonomous navigation modes. A software module is provided and executed for operation in a portable user computer device for enabling control and operation of the one or more UxS devices. The software module is configured for enabling the portable user computer device to communicate with one or more external communication devices regarding operation and control of the one or more UxSs. The software module communicatively couples the portable user computer device to the one or more UxSs via a transceiver component provided in the portable user computer device, wherein the software module enables voice commands received from a user at the portable user computer device to control one or more navigation functionalities for the one or more UxSs via the transceiver component.

### CROSS REFERENCE TO RELATED APPLICATIONS

This application claims priority to U.S. Patent Application Ser. No. 63/394,389 filed Aug. 2, 2022 which is incorporated herein by reference in its entirety.

### BACKGROUND

### 1. Field

The disclosed embodiments generally relate to a voice control system and method, and more particularly, to a system and method for providing autonomous uncrewed robotic operation of an uncrewed vehicle via voice commands inputted to a user device.

### 2. Description of Related Art

As mobile robotic devices become increasingly sophisticated, people are using such devices in new and interesting ways. Some of these robotic devices have adopted voice control where the device can perform various actions in response to spoken words or instruction. For example, in response to a spoken question or instruction, these devices can analyze the voice data to determine an appropriate action to be taken. In some cases, these devices, such as Uncrewed Aerial Vehicles (UAVs), can cause execution of certain navigational flights actions. However, such control functionality is often limited due to the inability of current systems to function in extremely noisy environments and to operate with enterprise and tactical uncrewed systems.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, described is a hands-free integrated digital operations software module, preferably implemented on a commercially available user communication device (e.g., pre-existing user portable computer devices configured to have primary a functionality directed to uses other than uncrewed vehicle operation, such as a smart phone device), that enables users in stressful environments to remotely pilot uncrewed systems and remain aware of what these systems are observing through audio inputs and cues. It is configured and operational to enable a user to focus on a task at hand, for example allowing a law enforcement officer to maintain awareness of their surroundings and hands on their weapon while also receiving cues from autonomous agents such as a flying uncrewed aerial system. The hands-free integrated digital operations software module is to be particularly applicable to environments with significant noise and autonomous platforms that are controllable by voice.

In another aspect, provided is a computer-implemented system and method for operating one or more uncrewed vehicles (UxSs) in autonomous navigation modes. A software module is provided and executed for operation in a portable user computer device (e.g., a smart phone device) for enabling control and operation of the one or more UxS devices. The software module is configured for enabling the portable user computer device to communicate with one or more external communication devices regarding operation and control of the one or more UxSs. The software module communicatively couples the portable user computer device to the one or more UxSs via a transceiver component provided in the portable user computer device, wherein the software module enables voice commands received from a user at the portable user computer device to control one or more navigation functionalities for the one or more UxSs via the transceiver component.

### BRIEF DESCRIPTION OF THE DRAWINGS

So that se skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates a system overview of an illustrated embodiment depicting a user portable computer device coupled to a plurality of unscrewed vehicle devices for control and operation thereof;

FIG. 2 illustrates an exemplary Uncrewed System (UxS) utilized with the illustrated embodiment of FIG. 1;

FIG. 3 illustrates a method of operation for a software module implemented on the portable computer device of FIG. 1; and

FIG. 4 illustrates one or more internal and external components of the computing devices of FIG. 1 in accordance with an illustrative embodiment of the present invention.

### DETAILED DESCRIPTION OF CERTAIN EMBODIMENTS

Aspects of the disclosed embodiments are shown in the following description and related drawings directed to specific illustrated embodiments. Alternate preferred embodiments may be devised without departing from the scope of the illustrated. Additionally, well-known elements of the illustrated embodiments will not be described in detail or will be omitted so as not to obscure the relevant details of the illustrated embodiments.

The word “exemplary” is used herein to mean “serving as an example, instance, or illustration.” Any embodiment described herein as “exemplary” is not necessarily to be construed as preferred or advantageous over other embodiments. Likewise, the term “illustrated embodiments” does not require that all illustrated embodiments include the discussed feature, advantage or mode of operation.

The terminology used herein is for the purpose of describing particular embodiments only and is not intended to be limiting of the illustrated embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any form of computer readable storage medium having stored therein a corresponding set of computer instructions that upon execution would cause an associated processor to perform the functionality described herein. Thus, the various aspects of the illustrated embodiments may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Where a range of values is provided, it is understood that each intervening value, to the tenth of the unit of the lower limit unless the context clearly dictates otherwise, between the upper and lower limit of that range and any other stated or intervening value in that stated range is encompassed within the illustrated embodiments. The upper and lower limits of these smaller ranges may independently be included in the smaller ranges is also encompassed within the illustrated embodiments, subject to any specifically excluded limit in the stated range. Where the stated range includes one or both of the limits, ranges excluding either both of those included limits are also included in the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described. All publications mentioned herein are incorporated herein by reference to disclose and describe the methods and/or materials in connection with which the publications are cited.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims. All publications and references cited herein are expressly incorporated herein by reference in their entirety.

Certain embodiments disclosed herein provide for Uncrewed Systems (UxSs) implemented for public safety detection purposes. For example, one method disclosed herein allows for a drone to patrol a battlefield environment for threat detection purposes, such as identifying an enemy combatant, weapon or vehicle. For ease of description purposes, the below illustrated embodiments are described with regards to the UxS being a Uncrewed Aerial Vehicle (UAV) implemented in a tactical battlefield environment, as to be further described below. However, and for the avoidance of doubt, the UxS of the illustrated embodiments is not to be understood to be limited to such a UAV for use in a battlefield environment, as it is to be understood to encompass a variety of UxS devices, such as, but not limited to, navigational robotic systems configured for land, surface, submersible navigation and/or space travel for detection of a variety of scenarios, including for instance those associated with law enforcement, scientific exploration and/or public safety concerns.

After reading this description it will become apparent to one skilled in the art how to implement the illustrated embodiments in various alternative embodiments and alternative applications. However, although various embodiments will be described herein, it is understood that these embodiments are presented by way of example only, and not limitation. As such, this detailed description of various alternative embodiments should not be construed to limit the scope or breadth of the illustrated embodiments as set forth in the appended claims.

Turning now descriptively to the drawings, in which similar reference characters denote similar elements throughout the several views, described herein is a hands-free integrated digital operations assistant/software system, preferably implemented on a commercially available user communication device (as described further below) that enables users, particularly in stressful environments, to remotely pilot uncrewed systems and remain aware of what these systems are observing through audio inputs and cues provided by a user. The hands-free system is specifically configured and operational to enable a user to focus on a task at hand, for example allowing a law enforcement officer to maintain awareness of their surroundings and hands on their weapon while also receiving cues from autonomous agents such as a flying uncrewed aerial system. As described below, it is to be appreciated the hands-free system is specifically configured to be applicable to multiple environments having significant noise such that the hands-free system provides autonomous platforms that are controllable by voice against the backdrop of a noisy environment.

As further described below, the system 10 preferably utilizes current commercially available user communication devices 110 (e.g., pre-existing user portable computer devices configured to have primary a functionality directed to uses other than uncrewed vehicle operation, such as a smart phone device) preferably having a machine learning acceleration processor, microphones, and network connection to external autonomous systems. Preferably, the illustrated embodiments include a software module 112 implemented on a communication device 110 that is configured and operative to capture audio data (e.g., voice), authenticate the audio data (e.g., voice), and interpret the audio data into speech for enabling high-level commands for a robotic system, such as a UxS 100. Observations by the autonomous system 10 are preferably relayed to a user of the communication device 110 through speakers or a headset coupled to the communication device 110.

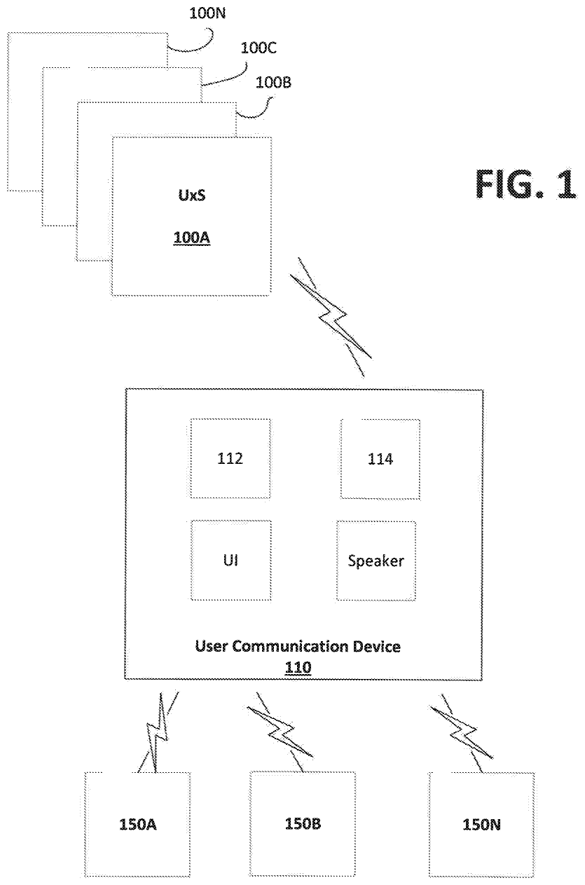

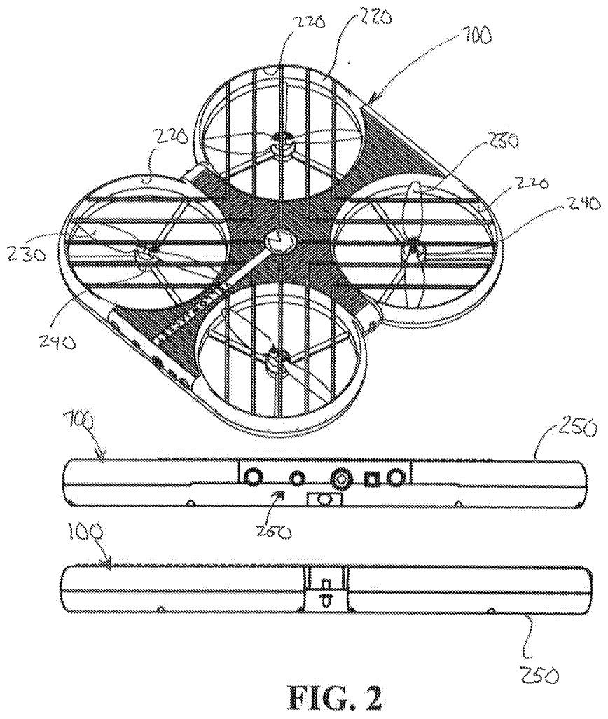

Turning now to FIG. 1, shown is a diagram illustrating an exemplary system 10 for UAV implemented patrol according to an illustrated embodiment. In the illustrated embodiment, the system 10 comprises a plurality of drone devices 100A-N. For brevity of description, and with reference to FIG. 2, an illustrative drone 100 preferably includes a generally planar body 210 enclosing a battery energy source. A plurality of duct openings 220 may be provided in the planar body 210 wherein a rotor 230 assembly is respectively rotatably mounted in each duct opening 220 for propulsion of the UAV 100. An electric motor assembly 240 is respectively coupled to each rotor assembly 230, whereby each electric motor assembly 240 is electrically coupled to the battery source. A camera assembly 250 is also provided in the body portion 210, as is a wireless communication interface device for controlling the UAV 100 and transmitting images from the camera assembly 250 to a mobile user communication device 110. An electronic controller is preferably coupled to the battery source configured to provide autonomous flight for the UxS 100, as described herein. For instance, such a UxS is shown and described in U.S. Pat. No. 9,944,366, incorporated herein by reference. As mentioned above, the UxS device 100 shown in FIG. 2 is provided for illustrative purposes only of an exemplary UxS 100 used in accordance with the illustrated embodiment of FIG. 1, as the UxS 100 of the illustrated embodiments is not to be understood to be limited to such a UxS.

With returning reference now to FIG. 1 (and with continuing reference to FIG. 2), described is a computer-implemented system 10 for providing autonomous UxS 100 operation, preferably via voice control of an operator of a user communication device 110. It is to be understood, the user communication device 110 is preferably a commercially available smart phone device 110 (e.g., an iPhone or Android device) whereby the software module 112 is an app installed on the smart phone device 110 enabling the functionality described herein in accordance with the illustrated embodiments. For instance, the smart phone device 110 preferably has an operating system consisting of either an iPhone or Android operating system that couples to one or more application repositories for downloading applications (apps) thereto.

As shown in FIG. 1, the user device 100 communicates with a single UxS 100 or simultaneously with a plurality of UxSs 100A-N. A software module 112 (e.g., a downloaded app) is preferably installed in the user communication device 110 so as to enable and configure, via the aforementioned provided communications components on the user communication device 110, the user communication device 110 to communicatively couple to the one or more UxSs 100A-N, preferably via a transceiver component 114 provided in the user communication device 110. In accordance with the illustrated embodiments, the software module 112 preferably enables voice commands received from a user at the user communication device 110 to control one or more autonomous navigation functionalities for the one or more UxSs 100A-N. The software module 112 is further configured and operable to provide user voice authentication and authorization for the user communication device 110, preferably using biometric voice recognition techniques. It is to be appreciated that the software module 112 may be configured to provide continuous authentication of voice commands from a user to the communication device 110.

In accordance with the illustrated embodiments, the user voice authentication and authorization utilizes multi-factor authentication and voice biometrics, whereby the multi-factor authentication may utilize brevity codes (e.g., codes are designed to convey complex information with a few words or codes). It is to be appreciated the brevity code may be either a rolling or static brevity code. It is to be further appreciated that the software module 112, upon detection of a brevity code uttered from an authorized user of the communication device 110, causes one or more actions to be initiated upon either the user communication device and/or the one or more UxSs 110A-N. For instance, a “follow me” brevity code, may cause one or more UxSs 100A-N to follow the user to detect the presence enemy combatants and/or enemy devices with a certain geofence surrounding the user of the communication device 110. Additionally, a brevity code may cause one or more actions to be initiated for locking and/or wiping data from the user communication device 110 and/or the one or more UxSs 100A-N. In accordance with the illustrated embodiments, it is to be appreciated that the software module 112 preferably utilizes machine learning models trained to enroll specific user voiceprints on the user communication device 110, wherein enrollment may include bone-conductivity and unique body-pressure measurements received in one or more external devices coupled to the communication device 110.

Additionally, the software module 112, may be configured to filter environmental noises (e.g., noises associated with a battlefield, such as explosions, shouting noises and/or engine noises) so as to accurately understand spoken words of the operator of the user communication device 110 when the operator is providing voice commands for the UxSs 110A-N. In accordance with the illustrated embodiments described herein, the software module 112 is further configured to simultaneously operate a plurality of UxSs 100A-N for execution of a common task (e.g., survey a geofenced area for detection of one or more elements/events—such as detection of one or more hostile conditions relative to the user (e.g., including one or more of shouting noises, weapons discharge, detection of enemy combatants, explosions and engines noises)) initiated by a user voice command to the communication device 110.

Upon receiving data from a UxS 100, such as captured by the camera assembly 250 of the UxS 100, the software module 112 of the communication device 110 is configured and operably to interpolate and provide audio and/or visual indication from the communication device 110 to a user of device 110 indicative of one or more events detected by the one or more UxSs 100 during flight. For instance, the detected events may be detection of enemy combatants (such as troops in motion), certain engine noises and/or when the sound level exposed to either the UxS 100 and/or user device 110 exceeds a prescribed decibel level.

Further, in accordance with the illustrated embodiments, the software module 112 is configured and operational to provide a signal from the user's communication device 110 to other external communication devices 150A-N (e.g., smart phones, tablet devices, tactical radios and other user communication devices) associated with other user's, which signal is indicative of an event detected by the user's communication device 110 (e.g., detection of a hostile combatant, and as further described below), which detected event may be a threat to either the user of the user communication device 110 or a threat detected from users of other communication devices 150A-N.

Additionally, the software module 112 may additionally be configured and operational to enable the associated user's communication device 110 to communicatively connect to external communication devices and/or components, such as tactical headsets (e.g., having bone conducting microphones) and/or radios either associated with the user of the communication device 110 or with other desired users 150 (e.g., other personal associated with the user). For instance, a user's voice commands for operation of the one or more UxSs 100A-N may be received at one or more microphone components associated with the user that are provided at a distance separate from the user communication device 110. Thus, the software module 112 integrates external audio sources (e.g., microphone headset devices) associated with the user, while enhancing the user's speech and leveraging advanced headsets for noise suppression.

Yet further, in accordance with certain illustrated embodiments, the software module 112 may be configured and operable to enable the user communication device 110 to monitor certain tactical communication networks and certain captured voice traffic. For instance, if grid coordinates are called out by a user of communication device 110, the software module 112 is configured and operable to record the spoken grid coordinates and confirm the locations hands-free with the user, thus significantly reducing the cognitive load of the user.

Accordingly, as described above, certain advantages and features of the illustrated embodiments include providing UxSs 100 with functionality designed for noisy environments encountered in dangerous situations including warzones and specifically targets autonomous robotic operation in tactical environments, preferably by leveraging advances in edge processors to mitigate the need for network connectivity to a cloud environment. For instance, it may be developed with tactical noise samples to aid in its ability to function in these environments. Additionally, it takes advantage of available headsets that use bone conducting microphones to further reduce noise inputs. It is to be appreciated that a key feature is the reduced vocabulary search space which increases the accuracy of translating speech to commands over other similar systems.

Additional features, as described above, include a troops in combat detector which listens for audio cues to alert others including autonomous platforms to potential risk situations. Continuous authentication of voice commands for autonomous systems is provided. It also provides integration with existing tactical radios employed by military users to ensure seamless integration of a user's communication device 110 into operational equipment, while providing multi-factor security, and recognizing “brevity codes” similar to passphrases/passwords.

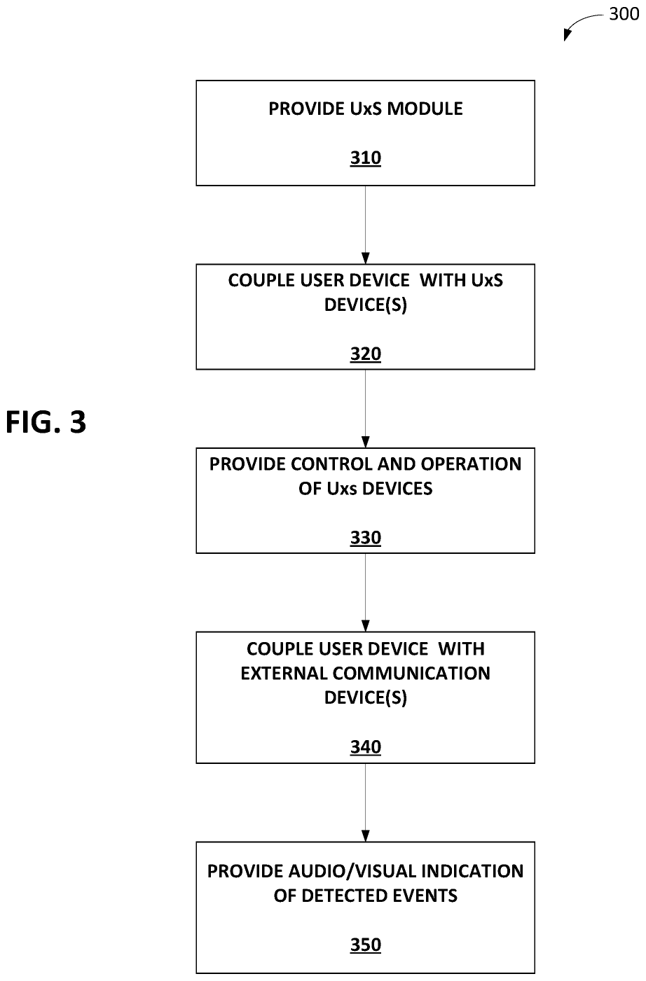

With the exemplary system 10 of FIG. 1 being generally shown and discussed above, with reference now to FIG. 3, provided is an exemplary computer-implemented method for causing operation and control of one or more uncrewed aerial vehicles (UxSs) 100a-100n (which may include autonomous navigation modes) from a portable user computer device 110, designated generally by process 300

It is to be understood and appreciated that computer-implemented process 300 depicts a flow chart demonstrating implementation of the various exemplary embodiments. It is noted that the order of steps shown in FIG. 3 is not required, so in principle, the various steps may be performed out of the illustrated order. Also certain steps may be skipped, different steps may be added or substituted, or selected steps or groups of steps may be performed in a separate application following the embodiments described herein.

Starting at step 310, a UxS software module 112 is provided, and is caused to be executes in a user's portable user computer device 110, such as a tablet device or a smart phone device. For instance, such a tablet and/or smart phone device 110 may use either the Android™ or Apple iOS™ operating system, wherein the software module 112 is caused to be downloaded from a compatible application repository such as an online accessible app store.

Once the software module 112 is caused to be executed on the user's portable computer device 110, the software module 112 then causes the user's portable computer device 110 to communicatively couple to the one or more UxS devices 100a-100n, step 320. It is to be understood and appreciated that each UxS device 100a-100n preferably includes a control system that is configured to enable wireless connectivity and data communication with a user's portable computer device 110 executing the aforesaid software module 112. Once wireless connectivity is established between the user's portable computer device 110 (using any suitable wireless communication protocol) and the one or more UxS devices 100a-100n, the software module 112 enable control and operation of the one or more UxS devices 100a-100n communicatively coupled to the portable user computer device 110, preferably via a transceiver component 114 provided in the portable user computer device 110, step 330. Preferably, the software module 112 enables voice commands received from a user at the portable user computer device 110 to control one or more control functionalities (including autonomous navigation functionalities) for the one or more UxS devices 100a-100n. For instance, such control of the one or more UxS devices 100a-100n includes causing the one or more UxS devices 100a-100n to survey the surroundings of a user in a certain environment, including, but not limited to a tactical battlefield environment, or causing the one or more UxS devices 100a-100n to follow a user within a configurable geofence. Additionally, such control may consist of causing the one or more UxS devices 100a-100n to detect one or more hostile conditions relative to the user, such as shouting noises, tactical sounds associated with public safety, weapons discharge, detection of enemy combatants, explosions, and engine noises. In certain embodiments, the software module 112 is configured to enable to the portable user computer device 110 to simultaneously operate and control a plurality of UxS device 100a-100n for execution of a common task, preferably initiated upon a spoken user voice command to the portable user computer device 110.

Preferably, the software module 112 is configured and operable to provide user voice authentication and authorization for the portable user computer device 110 using biometric voice recognition (which may also include multi-factor authentication techniques) for enabling the control and operation of the one or more UxS devices 110a-110n. In certain embodiments, the aforesaid authentication utilizes brevity codes spoken by the user of the portable user computer device 110. For instance, upon detection of a spoken brevity code, the software module 112 causes one or more actions to be initiated by the portable user computer device 110. It is to be appreciated the brevity code may be either a rolling or static brevity code, and wherein the one or more actions to be initiated is either upon the portable user computer device 110 and/or the one or more UxS devices 110a-110n, such as locking and/or wiping data from the portable user computer device 110 and/or the one or more UxS devices 110a-110n. In other embodiments the software module 112 is further configured to provide continuous authentication of voice commands from a user during operation and control of the one or more UxS devices 110a-110n. In other embodiments, the software module is further configured to filter environmental noises inflicted upon the portable user computer device when receiving user voice commands regarding the control and operation of the one or more UxS devices 100a-100n.

Next, at step 340, the portable user computer device 110 is caused to be communicatively coupled to one or more external communication devices 150a-150n regarding operation and control of the one or more UxS devices 100a-100n. For instance, the external communication devices 150a-150n may consist of tactical radios associated with the use of device 110 and/or with other users. Additionally, the external communication devices 150a-150n may consist of one or more speaker components and/or microphone components associated with the user of device 110 and/or other users, wherein the microphone components may include bone conducting microphones such that a user's voice commands for controlling operation of the one or more UxS devices 100a-100n are received at the one or more microphone components provided at a distance separate from the user's portable computer device 110.

Next, at step 350, the software module 112 is further configured to provide audio and/or visual indication (via a UI) on the portable user computer device 110 indicative of one or more events detected by the one or more UxSs 100a-100n during flight. For instance, the one or more events may include detection of one or more of shouting noises, tactical sounds associated with public safety, weapons discharge, detection of enemy combatants, explosions, noises that exceed a prescribed decibel level and engine noises. In certain embodiments, the detected event is detected threat to either the user of the portable computer device 110 and/or threat detected relative to other user's of other portable computer devices 150a-150n communicatively coupled to the user's portable computer device 112.

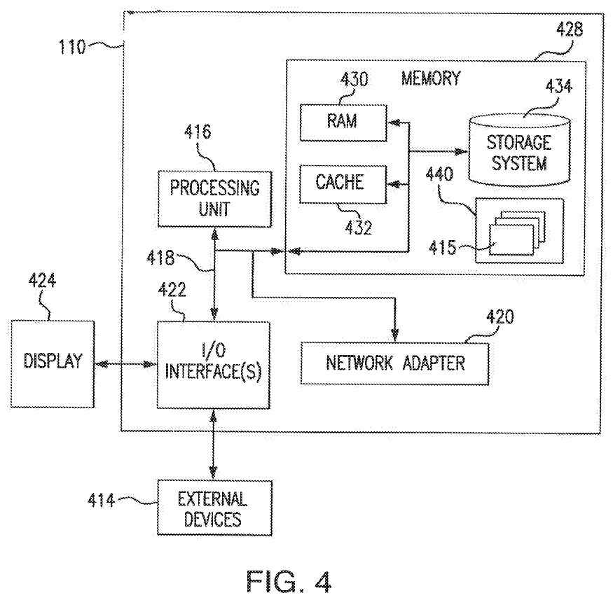

With the illustrated embodiments of FIGS. 1-3 described above, FIG. 4 illustrates one or more internal and external components provided in each of the user portable computer device 110, the one or more UxS device 100a-100n, and the external communication devices 150a-150n, in accordance with the above described illustrated embodiments.

In particular, the user portable computer device 110, the one or more UxS device 100a-100n, and the external communication devices 150a-150n may be described in the general context of computer system-executable instructions, such as program modules, being executed by a computer system. Generally, program modules may include routines, programs, objects, components, logic, data structures, and so on that perform particular tasks or implement particular abstract data types. The user portable computer device 110, the one or more UxS device 100a-100n, and the external communication devices 150a-150n may be practiced in networked coupled data processing environments where tasks are performed by remote processing devices that are linked through a communications network.

The user portable computer device 110, the one or more UxS device 100a-100n, and the external communication devices 150a-150n are generally shown in FIG. 4 in the form of general-purpose computing devices. The components of the user portable computer device 110, the one or more UxS device 100a-100n, and the external communication devices 150a-150n may include, but are not limited to, one or more processors or processing units 416, a system memory 428, and a bus 418 that couples various system components including the system memory 428 to the processor 416.

The bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The user portable computer device 110, the one or more UxS device 100a-100n, and the external communication devices 150a-150n typically include a variety of computer system readable media. Such media may be any available media that is accessible by the user portable computer device 110, the one or more UxS device 100a-100n, and the external communication devices 150a-150n, and it includes both volatile and non-volatile media, removable and non-removable media.

The system memory 428 can include computer system readable media in the form of volatile memory, such as random access memory (RAM) 430 and/or cache memory 432. The user portable computer device 110, the one or more UxS device 100a-100n, and the external communication devices 150a-150n may further include other removable/non-removable, volatile/non-volatile computer system storage media. By way of example only, a storage system 434 can be provided for reading from and writing to a non-removable, non-volatile magnetic media (not shown and typically called a “hard drive”). Although not shown, a magnetic disk drive for reading from and writing to a removable, non-volatile magnetic disk, and an optical disk drive for reading from or writing to a removable, non-volatile memory. In such instances, each can be connected to the bus 418 by one or more data media interfaces. As will be further depicted and described below, the memory 428 may include at least one program product having a set (e.g., at least one) of program modules that are configured to carry out the functions of embodiments of the invention.

A program/utility 440, having a set (at least one) of program modules 415 (e.g., module 112) that perform the disclosed methods may be stored in the memory 428 by way of example, and not limitation, as well as an operating system, one or more application programs, other program modules, and program data. Each of the operating system, one or more application programs, other program modules, and program data or some combination thereof, may include an implementation of a networking environment. Program modules 415 generally carry out the functions and/or methodologies of embodiments of the invention as described herein.

The user portable computer device 110, the one or more UxS device 100a-100n, and the external communication devices 150a-150n may also communicate with one or more external devices 414 such as a keyboard, a pointing device, a display 424, etc.; one or more devices that enable a user to interact with user portable computer device 110, the one or more UxS device 100a-100n, and the external communication devices 150a-150n; and/or any devices (e.g., network card, modem, etc.) that enable the user portable computer device 110, the one or more UxS device 100a-100n, and the external communication devices 150a-150n to communicate with one or more other computing devices. Such communication can occur via Input/Output (I/O) interfaces 422. Still yet, the user portable computer device 110, the one or more UxS device 100a-100n, and the external communication devices 150a-150n can communicate with one or more networks such as a local area network (LAN), a general wide area network (WAN), and/or a public network (e.g., the Internet) via a network adapter 420. As depicted, the network adapter 420 communicates with the other components of the user portable computer device 110, the one or more UxS device 100a-100n, and the external communication devices 150a-150n via the bus 418. It should be understood that although not shown, other hardware and/or software components could be used in conjunction with the user portable computer device 110, the one or more UxS device 100a-100n, and the external communication devices 150a-150n. Examples, include, but are not limited to: microcode, device drivers, redundant processing units, external disk drive arrays, RAID systems, tape drives, and data archival storage systems, etc.

The block diagrams in the Figures illustrate the architecture, functionality, and operation of possible implementations of systems, methods and computer program products according to various embodiments of the present invention. In this regard, operations described may be implemented by modules, segments, or portions of code, which comprise one or more executable instructions for implementing the specified logical function(s). It should also be noted that, in some alternative implementations, the functions described in various orders and/or substantially concurrently. It will also be noted that functions described can be implemented by special purpose hardware-based systems that perform the specified functions or acts, or combinations of special purpose hardware and computer instructions.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A system for operating one or more uncrewed vehicles (UxSs) in autonomous navigation modes, comprising:
providing one or more UxSs;
providing a software module in a portable user computer device, wherein the software module is configured for enabling the portable user computer device to communicate with one or more external communication devices regarding operation of the one or more UxSs;
wherein the software module communicatively couples the portable user computer device to the one or more UxSs via a transceiver component provided in the portable user computer device;
and wherein the software module enables voice commands received from a user at the portable user computer device to control one or more autonomous navigation functionalities for the one or more UxSs via the transceiver component.

2. The system as recited in claim 1, wherein the software module is configured to provide user voice authentication and authorization of a user for enabling use of the portable user computer device.

3. The system as recited in claim 1, wherein the software module is further configured to filter out environmental noises inflicted upon the portable user computer device when receiving user voice commands for operating the one or more UxSs and wherein the software module is further configured to cause the portable user computer device to provide either audio and/or visual indication of one or more detected events detected by the one or more UxSs during flight.

4. The system as recited in claim 1, wherein the portable user computer device is a smart phone device.

5. The system as recited in claim 4, wherein the detected events include detection of troops in combat.

6. The system as in claim 1, wherein the software module, upon detection of a brevity code spoken from a user of the portable user computer device, causes one or more actions to be initiated upon the one or more UxSs associated with the spoken brevity code.

7. The system as recited in claim 2, wherein the software module is further configured to provide continuous authentication of voice commands received from a user of the user's portable user computer device.

8. The system as recited in claim 1, wherein the software module is further configured to cause the portable user computer device to simultaneously operate a plurality of UxSs for execution of a common task initiated upon a user voice command received at the portable user computer device.

9. The system as recited in claim 8, wherein the common task includes causing the plurality of UxSs to follow a user within a configurable geofence.

10. The system as recited in claim 1, wherein the software module is further configured to provide a signal from the portable user computer device to other portable user computer devices associated with other user's indicative of an event detected by the one or more UxSs.

11. The system as recited in claim 1, wherein each of the one or more UxSs consists of one of: a robotics system configured for space, ground, surface, or submersible travel.

12. A computer-implemented method for causing operation and control of one or more uncrewed aerial vehicles (UxSs) in autonomous navigation modes from a portable user computer device, comprising:
providing one or more UxS devices; and
providing a UxS software module in the portable user computer device, wherein the software module is configured and operable to:
communicatively couple the portable user computer device to the one or more UxS devices;
enable control and operation of the one or more UxSs communicatively coupled to the portable user computer device, via a transceiver component provided in the portable user computer device, wherein the software module enables voice commands received from a user at the portable user computer device to control one or more autonomous navigation functionalities for the one or more UxSs; and
communicatively couple the portable user computer device to one or more other external communication devices regarding operation and control of the one or more UxS devices.

13. The method as recited in claim 12, wherein each of the one or more UxSs include a base having a transceiver and a rotor system comprising a motor and a plurality of rotors extending from the base.

14. The method as recited in claim 12, wherein the software module is configured and operable to provide user voice authentication and authorization for the portable user computer device using biometric voice recognition for enabling the control and operation of the one or more UxS devices.

15. The method as recited in claim 14, wherein the authentication utilizes brevity codes spoken by the user of the smart phone device, and wherein the software module is further configured to filter environmental noises inflicted upon the portable user computer device when receiving user voice commands regarding the control and operation of the one or more UxS devices.

16. The method as recited in claim 12, wherein portable user computer device consists of a smart phone device.

17. The method as recited in claim 12, wherein the software module is further configured to provide audio and/or visual indication on the portable user computer device indicative of one or more events detected by the one or more UxSs during flight.

18. The method as recited in claim 17, wherein the one or more detected events include detection of troops in combat.

19. The method as recited in claim 14, wherein the software module is further configured to provide continuous authentication of voice commands from a user during operation and control of the one or more UxS devices.

20. The method as recited in claim 12, wherein the software module is further configured to enable to the portable user computer device to simultaneously operate and control a plurality of UxSs for execution of a common task initiated upon a spoken user voice command.
